(19) United States
(12) Patent Application Publication
(10) Pub. No.: US 2025/0105316 A1
(43) Pub. Date: Mar. 27, 2025

(54) HIGH EFFICIENCY POWER SOLUTION BY INTEGRATION OF PRESSURIZED SOLID OXIDE FUEL CELL WITH EXPANDERS

(71) Applicant: NUOVO PIGNONE TECNOLOGIE - S.R.L., Florence (IT)

(72) Inventors: Pranav VENUTHURUPALLI, Karnataka (IN); Rama Raju VEGESNA, Karnataka (IN); Maneesh PANDEY, Karnataka (IN); Rahul WAGH, Karnataka (IN)

(21) Appl. No.: 18/730,967

(22) PCT Filed: Jan. 25, 2023
(86) PCT No.: PCT/EP2023/025036

§ 371 Date: Jul. 22, 2024

(30) Foreign Application Priority Data
Jan. 28, 2022 (IT) 102022000001484

(51) Int. Cl. H01M 8/04111; H01M 8/04014; H01M 8/12

(52) U.S. Cl. CPC H01M 8/04111; H01M 8/04022; H01M 2008/1293

(57) ABSTRACT

A solid oxide fuel cell system comprising an oxidant gas feed line and an oxidant gas compression system upstream said solid oxide fuel cell, a fuel feed line upstream said solid oxide fuel cell, a combustion chamber configured to combust unreacted fuel and oxidant gas downstream said solid oxide fuel cell, an exhaust gas line downstream said combustion chamber, a heat exchanger configured to allow heat exchange between said exhaust gas on the hot side of said heat exchanger and said oxidant gas and fuel on the cold side of said heat exchanger and an expansion system configured to expand said exhaust gas downstream said heat exchanger, wherein said oxidant gas compression system comprises a low pressure compressor, driven by an electric motor and a high-pressure compressor, driven by said expansion system by means of a common shaft.

### TECHNICAL FIELD

The present disclosure concerns a high efficiency power solution by integration of pressurized solid oxide fuel cell with turbomachinery. More specifically, the present disclosure concerns a system in which the compressor produces pressurized air for a solid oxide fuel cell and hot exhaust gas from the solid oxide fuel cell is expanded in the power recovery expander. The system is configured to operate with different types of expanders, including hot gas expanders, turbo expanders, low pressure expanders.

Embodiments disclosed herein specifically concern solid oxide fuel cell systems integrated with turbomachinery wherein each unit can operate individually from one another. According to the embodiments disclosed herein the compression system upstream the solid oxide fuel cell is a combination of an electric motor driven centrifugal or a reciprocating low pressure compressor and a high pressure compressor driven by a power recovery expander.

### Background Art

It is known that a fuel cell extracts work directly from the chemical potential energy, so that it can be used to bypass the entropy-generating combustion process which is predominant in a gas turbine.

In particular, solid oxide fuel cells (SOFCs) are energy conversion devices that produce electricity by electrochemically combining a fuel and an oxidant across an ionic conducting oxide electrolyte. The dense electrolyte is sandwiched between two porous electrodes, the anode and the cathode (the anode/electrolyte/cathode sandwich is referred to as a single cell). Fuel is fed to the anode, undergoes an oxidation reaction, and releases electrons to an external circuit. Oxidant is fed to the cathode, accepts electrons from the external circuit, and undergoes a reduction reaction. The electron flow in the external circuit from the anode to the cathode produces direct-current electricity. SOFCs operate at about 700 to 1000° C. under atmospheric or pressurized conditions depending on specific cell configurations and system designs.

In particular, it is well-known that SOFCs generate more power at higher pressure and temperature. Hence, an increase in operating pressure leads to a corresponding increase in power output from the SOFC for the same amount of fuel consumed. In order to achieve this result, a compressor at the inlet of the SOFC is required to pressurize the incoming air. However, SOFCs are not able to completely utilize the entire feed fuel. The unutilized fuel can be subjected to combustion downstream the SOFC, thereby raising exhaust streams enthalpy, that can be further recovered by means of expansion by integration of fuel cell with turbomachinery. Thus, electrical power is produced by both the solid oxide fuel cell generator and the turbine. For this reason, combining high efficiency of pressurized SOFCs with turbomachinery products has become an area of interest in order to reduce the overall fuel consumption for generating the same power.

U.S. Pat. No. 5,413,879A discloses an integrated gas turbine solid oxide fuel cell system in which a compressor produces compressed air that is pre-heated and then supplied to a solid oxide fuel cell generator. The solid oxide fuel cell generator, which is also supplied with a first stream of fuel, produces electrical power and a hot gas. In the solid oxide fuel cell generator, the unreacted portion of the fuel is combusted with oxygen remaining in the hot gas to further heat the hot gas. To fully utilize the potential of the exhaust stream, still at a high temperature, the further heated hot gas is then directed to a topping combustor that is supplied with a second stream of fuel so as to produce a still further heated hot gas that is then expanded in a turbine.

However, addition of excess fuel to generate surplus power from the turbine reduces the efficiency of such a system. Nevertheless, it cannot be avoided because the turbine has to run at its rated power while simultaneously driving the compressor.

As a result, the combined system according to the prior art is mechanically coupled as the compressor and power turbine in the unit are linked with one another. As such, it would be difficult to operate always at optimum conditions with respect to both the gas turbine and the SOFC.

Accordingly, an improved method of integrating solid oxide fuel cell with turbomachinery to address the efficiency limitation and coupling of the systems of the current art would be beneficial and would be welcomed in the technology. Further, an improved system to address the issues of addition of excess fuel thereby an additional combustor to generate surplus power from the turbine would also be welcomed. More in general, it would be desirable to provide an improved method of integrating solid oxide fuel cell with turbomachinery adapted to more effectively address the problems entailed by integrated gas turbine solid oxide fuel cell systems according to the prior art by offering higher efficiency thereby reducing the operative expense (OPEX) of the system on a long run while simultaneously reducing carbon emissions per kW.

### SUMMARY

In one aspect, the subject matter disclosed herein is directed to a solid oxide fuel cell system comprising a fuel feed line and an oxidant gas feed line with an oxidant gas compression system upstream the solid oxide fuel cell, an exhaust gas line downstream said solid oxide fuel cell, a heat exchanger configured to allow heat exchange between said exhaust gas on the hot side of said heat exchanger and said oxidant gas and fuel on the cold side of said heat exchanger and an expansion system configured to expand said exhaust gas downstream said heat exchanger, wherein the oxidant gas compression system comprises a low pressure compressor, driven by an electric motor and a high-pressure compressor, driven by said expansion system by means of a common shaft.

According to another aspect, a combustion chamber is arranged downstream said solid oxide fuel cell, to combust unreacted fuel and oxidant gas. The combustion chamber can be integral to or separate from said solid oxide fuel cell.

According to yet another aspect, the expansion system comprises an expander.

Alternatively, the expansion system comprises a high-pressure expander and a low pressure expander, configured to expand said exhaust gas downstream said heat exchanger, an additional heat exchanger being configured to allow heat exchange between the exhaust gas from the heat exchanger upstream the high-pressure expander on the hot side of the second heat exchanger and an exhaust gas stream downstream said high-pressure expander; and a low pressure expander configured to expand the exhaust stream downstream the second heat exchanger. In particular, the low pressure expander can be connected to the high pressure expander and to the high-pressure compressor by means of a common shaft.

In particular, according to one aspect, the oxidant gas for reaction in the solid oxide fuel cell is air.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a schematic of a solid oxide fuel cell system integrated with turbomachinery, according to a first embodiment; and

FIG. 2 illustrates a schematic of a solid oxide fuel cell system integrated with turbomachinery, according to a second embodiment.

### DETAILED DESCRIPTION OF EMBODIMENTS

According to one aspect, the present subject matter is directed to a solid oxide fuel cell system integrated with turbomachinery to provide a high efficiency power generation solution. In particular, this aim is achieved by combining a two stage compression-SOFC system with one or more expanders at the outlet of the fuel cell to further recover the energy present in the high pressure, high temperature exhaust of SOFC. The proposed combination offers higher efficiency when compared with conventional power generation systems thereby reducing the operative expense (OPEX) of the system on a long run while simultaneously reducing the carbon emissions per kW.

According to one aspect, the proposed subject matter allows to cope with increasing future energy demand for both industrial and micro grid applications while respecting more stringent emission norms.

According to one aspect, the proposed subject matter offers high efficiency over a wide range of operating pressures and can cater to both industrial and microgrid applications. This would mean same power can be produced by considerably lower fuel, which also translates to lower emissions.

According to one aspect, the proposed subject matter is more efficient at lower pressures when compared to integrated gas turbine SOFC systems because it takes advantage of the fact that additional power demanded by compression when supplied by an electric motor is more efficient than by fuel addition at lower pressures.

According to another aspect, the proposed subject matter is also compatible with lower mass flow rates and is capable to work in lower power ranges, making it an attractive offering for microgrid applications.

According to still another aspect, since exhaust gas temperature from SOFC can be higher than the temperature limit of some low power expanders, a different configuration is needed to control the expander inlet temperature. According to this configuration, a heat exchanger is provided to lower the temperature of the exhaust stream from the SOFC and directed to the first expander by exchanging heat with the outlet stream from the first expander. The outlet stream enthalpy from first expander is thus consequently increased after heat exchanger and can be further recovered by means of a second expander.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments, the articles “a”, “an”, “the”, and “said” are intended to mean that there are one or more of the elements. The terms “comprising”, “including”, and “having” are intended to be inclusive and mean that there may be additional elements other than the listed elements.

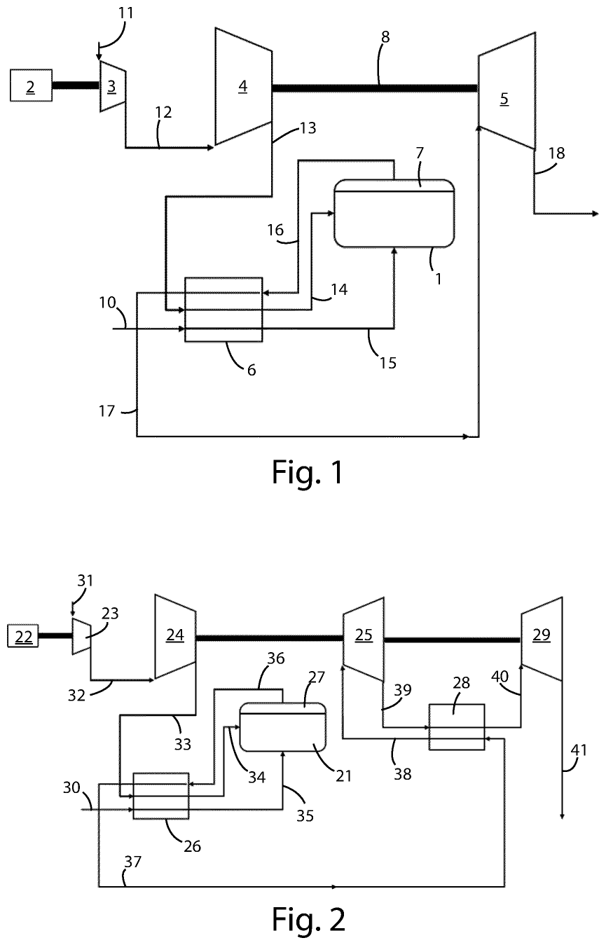

Referring now to the drawings, FIG. 1 shows a schematic of an exemplary solid oxide fuel cell system integrated with turbomachinery. At the centre of the proposed configuration is a pressurized solid oxide fuel cell (SOFC) system 1 that facilitates electro chemical reaction between air and fuel to generate electric power. A low pressure compressor 3, which is driven by an electric motor 2 and a high-pressure compressor 4, which is driven by a gas expander 5, are arranged on a solid oxide fuel cell (SOFC) air feed line upstream the SOFC system 1, and are configured to compress air directed to the SOFC system 1 by means of dual stage compression. A heat exchanger 6 is arranged on the SOFC air feed line, downstream the high-pressure compressor 4 and is configured to allow heat exchange between air from the high-pressure compressor 4 and an exhaust gas 16 from the SOFC system 1. The heat exchanger 6 is also configured to allow heat exchange between a fuel stream of a SOFC fuel feed line, upstream the SOFC system 1 and the exhaust gas 16 from the SOFC system 1. SOFC system 1 consists of an integral zone or combustion chamber 7 to facilitate combustion of air and unutilized fuel from said SOFC fuel feed line. Finally, the expander 5 is arranged on the SOFC system exhaust line, downstream the heat exchanger 6 and is driven by hot exhaust gas stream 17. The expander 5 is connected to the high-pressure compressor 4 by means of a common shaft 8.

While in the schematic of FIG. 1 described so far the heat exchanger 6 is external to the SOFC system 1, in other embodiments the heat exchanger 6 can be integral to the SOFC system 1.

While in the schematic of FIG. 1 described so far the combustion chamber 7 is integral to the SOFC system 1, in other embodiments the combustion chamber 7 is external to the SOFC system 1. In any case, this combustion chamber 7 shall facilitate combustion of only the air and unutilized fuel from said SOFC fuel feed line.

According to the present disclosure, the first embodiment shall always include:
an electric motor driven low pressure compressor;
a high pressure compressor;
an expander driving said high-pressure compressor;
a heat exchanger to facilitate heat exchange between low temperature and high temperature streams; and
a solid oxide fuel cell system consisting of:
   means to receive compressed air or any other compatible oxidant from compression system;
   means to receive any compatible fuel, including but not limited to natural gas, ammonia, hydrogen, biogas;
   means to pre-heat received compressed oxidant and fuel;
   means to produce electrical power by means of electro chemical reaction between received fuel and oxidant;
   means to combust fuel and oxidant which are unutilized in the electro chemical reaction.

Additionally, according to the present disclosure, solid oxide fuel cell can be replaced by any fuel cell which is adapted to operate at similar pressure and temperature conditions at similar or higher efficiencies.

The solid oxide fuel cell system integrated with turbomachinery shown in FIG. 1 operates as follows. Air to the SOFC system 1 is compressed by means of dual stage compression wherein an air stream is directed through an air stream line 11 to the low pressure compressor 3, to undergo a first stage of compression, and the air stream from the first stage of compression is directed through a partially compressed air stream line 12 to the high-pressure compressor 4, which is driven by the gas expander 5, to be further compressed in a second stage of compression. A compressed air stream 13 is discharged from the high-pressure compressor 4 and, before being fed to the SOFC system 1, is directed to the heat exchanger 6, in order to be brought to SOFC compatible temperature levels by means of heat exchange with an exhaust gas stream 16 coming from SOFC system 1. The heat exchanger 6 also heats a fuel stream, which is routed from an external source through a fuel stream 10. The heated air and the heated fuel from the heat exchanger 6 are then directed to the SOFC system 1, through a heated air stream line 14 and a heated fuel stream line 15. In the SOFC system 1, the heated air and the heated fuel undergo electro chemical reaction at cathode and anode respectively to generate electrical power. Unutilized fuel and air are routed to the combustion chamber 7, wherein they undergo combustion. This combustion further increases the temperature of the exhaust gas stream from the combustion chamber 7. The high temperature exhaust gas stream is then directed to the heat exchanger 6 through a hot exhaust gas stream line 16 and, after losing a certain amount of heat in the heat exchanger 6, is directed to the expander 5 through a high pressure exhaust gas stream line 17. The high pressure exhaust gas stream is then expanded in the expander 5. The expander 5 transmits the power generated due to this expansion to drive the high-pressure compressor 4 by means of a common shaft 8.

### Example 1

With continuing reference to FIG. 1, an example is disclosed in the following. In the following example, the same reference numbers designate the same or corresponding parts, elements or components already illustrated in FIG. 1 and described above, and which will not be described again.

Under this example, a maximum inlet pressure of 4 bara was imposed as operating limit for the expander 5, this value being a structural limitation of many high gain expanders on the market.

According to this example, the SOFC 7 parameters were the following:
Operating pressure: ˜5 bar
Exhaust temperature: 800° C.
Cell Voltage: 0.841 V
Internal reformer type with 100% efficiency

The operating parameters of the electric motor 2 driven low pressure compressor 3 were the following:
Pressure ratio: 1.5, Stream: Air, Mass flow rate: 20 kg/s
Isentropic efficiency: 85.7%
Mechanical efficiency: 97%
EMGB efficiency: 90%

The operating parameters of the high pressure compressor 4 were the following:
Pressure ratio: 4, Stream: Air, Mass flow rate: 20 kg/s
Isentropic efficiency: 85.7%
Mechanical efficiency: 97%

The operating parameter of the expander 5 were the following:
Pressure ratio: 4; 22.7 kg/s flow: Inlet temp: 482° C.
Isentropic efficiency: 85%

The operating parameter of the heat exchanger 6 were the following:
Effectiveness: 60%
Pressure drop considered across heat exchanger: 1.5 bar
Maximum Temperature: 800° C.

Always with continuing reference to FIG. 1, the same reference numbers designating the same streams already illustrated in FIG. 1 and described above, the parameter values for each stream are illustrated in Table 1:

TABLE 1

| | | Temp | Pressure | Flow rate |
|---|---|---|---|---|
| Ps. | Fluid | (° C.) | (bar) | (kg/s) |
| 11 | Air @ Blower. Inlet | 15 | 1 | 20 |
| 12 | Air @ Blower Outlet | 56.3 | 1.5 | 20 |
| 13 | Air @ HPC Outlet | 243 | 6 | 20 |
| 14 | Air @ FC Inlet | 566.2 | 5 | 20 |
| 15 | Natural gas @ FC Inlet | — | — | 0.31 |
| 16 | Combusted Mixture | 800 | 4.5 | 20.31 |
| 17 | HGE Inlet | 482 | 4 | 20.31 |
| 18 | HGE Exhaust | 272 | 1 | 20.31 |

The fuel consumption and corresponding powers for the components in example 1 were derived from the above assumptions and are as follows:
SOFC fuel inlet: 0.31 kg/s
Fuel cell electric power: 9762 kW
Shaft net power: 241 kW
EM power: 946 kW
Total net power: 9057 kW

The resulting efficiency of this integrated system of example 1 being equal to 60.42%.

From the above example it is evident that a system as the one defined according to the present disclosure for a power range up to 10 MW can function utilizing the exhaust of a fuel cell to further recover energy through an expander thereby further increasing the overall efficiency of the system. In the absence of this integration of an expander with the fuel cell, the power required to compress air would be derived from the fuel cell, thus reducing the system efficiency. The efficiency of the system increases with pressure up to an optimum pressure and remains constant thereafter. The change in efficiency of the system from the above example up to a pressure of 10 bar can be verified in a range of 60.42% to 63.5%. After an efficiency of 63.5% is achieved, then the efficiency remains constant with substantial impact on materials, with the need of selecting high pressure resistant materials.

### Example 2

With continuing reference to FIG. 1, a further example is disclosed in the following. Under this example, a maximum inlet pressure of 4 bara was imposed as operating limit for the expander 5. A smaller amount of air flow, namely 2 kg/s, was used according to the present example in order to demonstrate the adaptability of the solution for low power

According to this example, the SOFC 7 parameters were the following:
Operating pressure: ˜5 bar
Exhaust temperature: 800° C.
Cell Voltage: 0.841 V
Internal reformer type with 100% efficiency

The operating parameter of the electric motor 2 driven low pressure compressor 3 were the following:
Pressure ratio: 1.5, Stream: Air, Mass flow rate: 2 kg/s
Isentropic efficiency: 85.7%
Mechanical Efficiency: 97%
EMGB Efficiency: 90%

The operating parameter of the high pressure compressor 4 were the following:
Pressure ratio: 4, Stream: Air, Mass flow rate: 2 kg/s
Isentropic efficiency: 85.7%
Mechanical Efficiency: 97%

The operating parameter of the expander 5 were the following:
Pressure ratio=4
Isentropic efficiency: 80%

The operating parameter of the heat exchanger 6 were the following:
Effectiveness: 60%
Pressure drop considered across heat exchanger: 1.5 bar
Maximum Temperature: 800° C.

Always with continuing reference to FIG. 1, the same reference numbers designating the same streams already illustrated in FIG. 1 and described above, the parameter values for each stream are illustrated in Table 2:

TABLE 2

| | | Temp | Pressure | Flow rate |
|---|---|---|---|---|
| Ps. | Fluid | (° C.) | (bar) | (kg/s) |
| 11 | Air @ Blower. Inlet | 15 | 1 | 2 |
| 12 | Air @ Blower Outlet | 56.3 | 1.5 | 2 |
| 13 | Air @ HPC Outlet | 243 | 6 | 2 |
| 14 | Air @ FC Inlet | 566.2 | 5 | 2 |
| 15 | Natural gas @ FC Inlet | — | — | 0.031 |
| 16 | Combusted Mixture | 800 | 4.5 | 2.031 |
| 17 | TEX Inlet | 482 | 4 | 2.031 |
| 18 | TEX Outlet | 284.3 | 1 | 2.031 |

The fuel consumption and corresponding powers for the components in example 2 were derived from the above assumptions and are as follows:
SOFC fuel inlet: 0.031 kg/s
Fuel cell electric power: 976 kW
Shaft net power: 0 kW
EM power: 95 kW
Total power: 881 kW)

The resulting efficiency of this integrated system of example 2 being equal to 58.8%

From the above example it is evident that a system as the one defined according to the present disclosure for a power range up to 1 MW for microgrid applications can function utilizing the exhaust of a fuel cell to further recover energy through an expander thereby further increasing the overall efficiency of the system. In the absence of this integration of an expander with the fuel cell, the power required to compress air would be derived from the fuel cell, thus reducing the system efficiency. The efficiency of the system increases with pressure up to an optimum pressure and remains constant thereafter. The lower efficiency for low power application is due to lower isentropic efficiency of the expanders selected in the power range. The change in efficiency of the system from the above example up to a pressure of 7 bar can be verified in a range of 58.8 to 60.5%.

Referring now to FIG. 2 a schematic is shown of an exemplary solid oxide fuel cell system integrated with turbomachinery according to a second embodiment. At the centre of the proposed configuration is a SOFC system 21 that facilitates electro chemical reaction between air and fuel to generate electric power. A low pressure compressor 23, which is driven by an electric motor 22 and a high-pressure compressor 24, which is driven by a high-pressure expander 25, are arranged on a SOFC air feed line, upstream the SOFC system 21, and are configured to compress air directed to the SOFC system 21 by means of dual stage compression. A heat exchanger 26 is arranged on the SOFC air feed line, downstream the high-pressure compressor 24 and is configured to allow heat exchange between air from the high-pressure compressor 24 and an exhaust gas from the SOFC system 21. The heat exchanger 26 is also configured to allow heat exchange between a fuel stream 30 of a SOFC fuel feed line, upstream the SOFC system 21 and the exhaust gas 36 from the SOFC system 21. SOFC system 21 should consist an integral zone or combustion chamber 27 to facilitate combustion of air and unutilized fuel from the stream 35. The high-pressure expander 25 is arranged on the SOFC system exhaust line 37, downstream the heat exchanger 26. The high-pressure expander 25 is connected to the high-pressure compressor 24 by means of a common shaft.

According to this second embodiment, a second heat exchanger 28 is arranged on the SOFC system exhaust line 37, upstream the high-pressure expander 25 and is configured to allow lowering the temperature of the high pressure exhaust stream 37 from the heat exchanger 26 by exchanging heat with the exhaust gas stream 39 from the high-pressure expander 25. This configuration is needed when the temperature of SOFC exhausts after heat exchange with air and fuel directed to the SOFC system 21 is still higher than typical temperature limitations on low power expanders and inlet temperature is a constraint for the expander designs. Finally, a low pressure expander 29 is arranged on the exhaust stream 40, downstream the heat exchanger 28 to further recover available energy. The low pressure expander 29 is connected to the high pressure expander 25 and to the high-pressure compressor 24 by means of a common shaft. Splitting the expansion in two stages also allows using the SOFC exhaust to heat the low temperature exhaust 39 of the high pressure expander 25, thus increasing the efficiency of the system when single stage expansion is not possible due to the constraint of high inlet temperature.

While in the schematic of FIG. 2 described so far the combustion chamber 27 is integral to the SOFC system 21, in other embodiments the combustion chamber 27 is external to the SOFC system 21. In any case, this combustion chamber shall facilitate combustion of only the air and unutilized fuel from stream 35

According to the present disclosure, the second embodiment shall always include:
an electric motor driven low pressure compressor;
a high pressure compressor;
turboexpanders with reheating capability driving said high-pressure compressor;
heat exchangers to facilitate heat exchange between low temperature and high temperature streams; and
a solid oxide fuel cell system consisting of:
   means to receive compressed air or any other compatible oxidant from compression system,
   means to receive any compatible fuel,
   means to pre-heat received compressed oxidant and fuel,
   means to produce electrical power by means of electro chemical reaction between received fuel and oxidant,
   means to combust fuel and oxidant which are unutilized in the electro chemical reaction.

Additionally, according to the present disclosure, solid oxide fuel cell can be replaced by any fuel cell which is adapted to operate at similar pressure and temperature conditions at similar or higher efficiencies.

The solid oxide fuel cell system integrated with turbomachinery shown in FIG. 2 operates as follows. Air to the SOFC system 21 is compressed by means of dual stage compression wherein an air stream is directed through an air stream line 31 to the low pressure compressor 23, to undergo a first stage of compression, and the air stream from the first stage of compression is directed through a partially compressed air stream line 32 to the high-pressure compressor 24, which is driven by the high pressure expander 25 and low pressure expander 29, to be further compressed in a second stage of compression. The compressed air stream 33 is discharged from the high-pressure compressor 24 and, before being fed to the SOFC system 21, is directed to the heat exchanger 26, in order to be bought to SOFC compatible temperature levels by means of heat exchange with an exhaust gas stream 36 coming from SOFC system 21. The heat exchanger 26 also heats a fuel stream, which is routed from an external source through a fuel stream 30. The heated air and the heated fuel from the heat exchanger 26 are then directed to the SOFC system 21, through a heated air stream line 34 and a heated fuel stream line 35. In the SOFC system 21, the heated air and the heated fuel undergo electro chemical reaction at cathode and anode respectively to generate electrical power. Unutilized fuel and air are routed to the combustion chamber 27, wherein they undergo combustion. This combustion further increases the temperature of the exhaust gas stream from the combustion chamber 27. The high temperature exhaust gas stream is then directed to the heat exchanger 26 through a hot exhaust gas stream line 36 and, after losing a certain amount of heat in the heat exchanger 26, is directed first to a second heat exchanger 28 through a high pressure exhaust gas stream line 37. The second heat exchanger 28 allows to lower the temperature of the high pressure exhaust gas stream 37 before it is routed to the high pressure expander 25 through a high pressure exhaust gas stream line 38, by exchanging heat with the exhaust gas stream from the high-pressure expander 25, which is routed to the second heat exchanger 28 through an exhaust gas stream line 39. Finally, downstream the heat exchanger 28 the exhaust gas from the high pressure expander 25 is directed to a low pressure expander 29 through a low pressure expander feed line 40. The expansion of the exhaust gas stream in the low pressure expander allows to generate additional power. This additional power along with the power generated due to expansion at expander 25 is transmitted to the high pressure compressor 24 by means of a common shaft.

### Example 3

With continuing reference to FIG. 2, an example is disclosed in the following. In the following example, the same reference numbers designate the same or corresponding parts, elements or components already illustrated in FIG. 2 and described above, and which will not be described again.

Under this example, a pressure of 10 bara was applied to the SOFC system 21.

According to this example, SOFC 21 parameters were the following:
Operating pressure: 10 bar
Exhaust temperature: 800° C.
Cell Voltage: 0.859 V
Internal reformer type with 100% efficiency

The operating parameter of the electric motor 22 driven low pressure compressor 23 were the followings:
Pressure ratio: 2, Stream: Air, Mass flow rate: 2 kg/s
Isentropic efficiency: 85.7%
Mechanical Efficiency: 97%
EMGB Efficiency: 90%

The operating parameter of the high pressure compressor 24 were the followings:
Pressure ratio: 5.5, Stream: Air, Mass flow rate: 2 kg/s
Isentropic efficiency: 85.7%
Mechanical Efficiency: 97%

The operating parameter of the high pressure expander 25 were the followings:
Pressure ratio=2.9
Isentropic efficiency: 80%

The operating parameter of the low pressure expander 29 were the followings:
Pressure ratio=2.43
Isentropic efficiency: 80%

Always with continuing reference to FIG. 2, the same reference numbers designating the same streams already illustrated in FIG. 2 and described above, the parameter values for each stream are illustrated in Table 3:

TABLE 3

| | | Temp | Pressure | Flow rate |
|---|---|---|---|---|
| Ps. | Fluid | (° C.) | (bar) | (Kg/s) |
| 31 | Air @ Blower. Inlet | 15 | 1 | 2 |
| 32 | Air @ Blower Outlet | 115.5 | 2.5 | 2 |
| 33 | Air @ HPC Outlet | 354.5 | 11 | 2 |
| 34 | Air @ FC Inlet | 576.8 | 10 | 2 |
| 35 | Natural gas @ FC Inlet | — | — | 0.031 |
| 36 | Combusted Mixture | 800 | 9.5 | 2.031 |
| 37 | HX2 Hot Inlet | 580 | 9 | 2.031 |
| 38 | HPE Inlet | 432 | 8.5 | 2.031 |
| 39 | HPE Outlet | 284 | 2.93 | 2.031 |
| 40 | LPE Inlet | 432 | 2.43 | 2.031 |
| 41 | LPE Outlet | 307.2 | 1 | 2.031 |

The fuel consumption and corresponding powers for the components in example 3 were derived from the above assumptions and are as follows:
Fuel cell fuel inlet: 0.031 kg/s
Fuel cell electric power: 997 kW
Shaft net power: 38 kW
EM power: 230 kW
Total power: 805 kW

The resulting efficiency of this integrated system of example 3 being equal to 53.7%.

The example is applicable in case of challenges in dealing with high exhaust temperature from SOFC or high inlet temperatures at expanders. According to this embodiment of the present disclosure an intercooling heat exchanger is introduced, allowing to reduce the temperature of the feed to the high pressure expander 25. The changes in efficiency of the system is attributed to additional equipment pressure losses leading to lower enthalpy available for expansion.

While aspects of the invention have been described in terms of various specific embodiments, it will be apparent to those of ordinary skill in the art that many modifications, changes, and omissions are possible without departing from the spirt and scope of the claims. In addition, unless specified otherwise herein, the order or sequence of any process or method steps may be varied or re-sequenced according to alternative embodiments.

1. A solid oxide fuel cell system comprising an oxidant gas feed line and an oxidant gas compression system upstream said solid oxide fuel cell, a fuel feed line upstream said solid oxide fuel cell, a combustion chamber configured to combust unreacted fuel and oxidant gas downstream said solid oxide fuel cell, an exhaust gas line downstream said combustion chamber, a heat exchanger configured to allow heat exchange between said exhaust gas on the hot side of said heat exchanger and said oxidant gas and fuel on the cold side of said heat exchanger and an expansion system configured to expand said exhaust gas downstream said heat exchanger, wherein said oxidant gas compression system comprises a low pressure compressor, driven by an electric motor and a high-pressure compressor, driven by said expansion system by means of a common shaft.

2. The solid oxide fuel cell system of claim 1, wherein said combustion chamber is integral to said solid oxide fuel cell.

3. The solid oxide fuel cell system of claim 1, wherein said combustion chamber is separate from said solid oxide fuel cell.

4. The solid oxide fuel cell system of claim 1, wherein said expansion system comprises an expander.

5. The solid oxide fuel cell system of claim 1, wherein said expansion system comprises a high-pressure expander, configured to expand said exhaust gas downstream said heat exchanger, a second heat exchanger configured to allow heat exchange between said exhaust gas from said heat exchanger upstream said high-pressure expander on the hot side of said second heat exchanger and an exhaust gas stream downstream said high-pressure expander; and a low pressure expander configured to expand said exhaust stream downstream said second heat exchanger, said low pressure expander being connected to said high pressure expander and to said high-pressure compressor by means of a common shaft.

6. The solid oxide fuel cell system of claim 1, wherein said expanders are selected from hot gas expanders, turbo expanders, low pressure expanders.

7. The solid oxide fuel cell system of claim 1, wherein said fuel is selected from natural gas, ammonia, hydrogen, biogas.

8. The solid oxide fuel cell system of claim 1, wherein said oxidant gas is air.
